(19) United States
(12) Patent Application Publication
(10) Pub. No.: US 2016/0280547 A1
(43) Pub. Date: Sep. 29, 2016

(54) METHOD OF SEPARATING AND RECOVERING OPTICALLY ACTIVE CARBON NANOTUBE, AND OPTICALLY ACTIVE CARBON NANOTUBE

(71) Applicant: NATIONAL INSTITUTE OF ADVANCED INDUSTRIAL SCIENCE AND TECHNOLOGY, Tokyo (JP)

(72) Inventors: Huaping LIU, Tsukuba-shi (JP); Takeshi TANAKA, Tsukuba-shi (JP); Hiromichi KATAURA, Tsukuba-shi (JP)

(21) Appl. No.: 14/777,975

(22) PCT Filed: Mar. 26, 2014
(86) PCT No.: PCT/JP2014/058538

§ 371 Date: Sep. 17, 2015

(30) Foreign Application Priority Data
Mar. 26, 2013 (JP) 2013-064895

(51) Int. Cl. C01B 31/02; B01D 15/08; B01J 20/291; B01J 20/24; B01J 20/28

(52) U.S. Cl. CPC C01B 31/0266; B01J 20/24; B01J 20/28047; B01J 20/291; B01D 15/08; B82Y 40/00

(57) ABSTRACT

The object of the present invention is to provide a method of accurately separating optically active CNTs with single (n, m), as well as optically active carbon nanotubes obtained by the method. A plurality of gel-filled columns are connected in series. An excess amount of carbon nanotube dispersion passes therethrough, so that carbon nanotubes with specific optical activities are adsorbed to each of the columns. The carbon nanotubes are eluted by an eluent. In this manner, optically active carbon nanotubes with specific structures can be separated with high accuracy.

### TECHNICAL FIELD

The present invention relates to a method of efficiently separating optically active carbon nanotubes using gel and to optically active carbon nanotubes obtained by the method.

### BACKGROUND ART

Single-wall carbon nanotubes (CNTs) are excellent in such properties as optical properties, electrical properties and mechanical strength, and research and development has been vigorously underway as ultimate new material. CNTs have a structure in which a graphene sheet where carbon atoms are arranged in a hexagonal pattern is seamlessly wrapped. There are different structures depending on the direction in which the sheet is wrapped and the thickness. CNTs are synthesized by various methods such as laser vaporization method, arc discharge method and chemical vapor deposition method (CVD method). Any of the synthesis methods can currently produce only a mixture of those having various different structures. CNTs are different in electrical properties depending on the structure. CNTs could be conductors or semiconductors, and the band gaps of the semiconducting CNTs are different when the CNTs are different in structure. In order to apply CNTs in the field of electronics, the CNTs are required to be uniform in electrical properties. Accordingly, the separation of metallic and semiconducting CNTs and separation of single-structure CNTs have been actively studied as an important challenge to realize next-generation electronics.

The structures of CNTs are uniquely defined by chiral indices, or a pair of two integers (n, m) (n m). However, (n, m) does not take into account optically active CNTs that are in a mirror image relationship, and CNTs that are in a mirror image relationship are not usually distinguished. Incidentally, metallic CNTs and semiconducting CNTs are obtained as a result of classification of carbon nanotubes by electric properties. Metallic CNTs are defined as those with chiral indices: n−m=(multiples of 3). Semiconducting CNTs are defined as others (“n−m” is not equal to multiples of 3) (Non-Patent Document 1).

Research on separation of single-structure CNTs has so far been conducted in several cases. However, the cases where research was conducted on separation of single-structure optically active CNTs in a mirror image relationship were actually limited. CNTs of a completely single structure with optical activity taken into consideration will be a very crucial material since the material could lead to new applications that are totally different from applications of existing CNTs. However, there has so far been no excellent separation method, and there are persistent calls for development of a new method.

The CNT optical resolution methods so far reported have problems with industrial production of optically active CNTs. The problems include:

(1) a mixture of CNTs with various indices (n, m) even though the CNTs are optically active; (2) the need for expensive equipment and chemicals; (3) mass processing is not available; (4) a long time is required; (5) automation is impossible because of complicated processes; and (6) optically active dispersants are required to be used.

For example, there is a method of synthesizing optically active tweezers-like molecules, dispersing CNTs by using the molecules, and selectively extracting and separating optically active CNTs (Non-Patent Documents 2 to 6). Among the above problems, the method requires special optically active molecules to be separately synthesized. Therefore, there are problems in terms of costs and mass processing. In particular, the method (Non-Patent Documents 2 to 5) fails to resolve the problem associated with a mixture of optically active CNTs with various indices (n, m) that are obtained.

There is a method (Non-Patent Document 7) of synthesizing optically active polymers, dispersing CNTs by using the polymers, and selectively extracting and separating optically active CNTs. However, the method similarly requires special optically active molecules to be separately synthesized. Therefore, there are problems in terms of costs and mass processing. Moreover, the method fails to resolve the problem associated with a mixture of optically active CNTs that are obtained, mostly those with indices (7, 5) and (6, 5).

There is a method (Non-Patent Document 8) of using flavin mononucleotide, which is a biological molecule, to disperse CNTs, and selectively extracting and separating optically active CNTs. However, the substance is very expensive because it is derived from a living organism, and there are problems in terms of costs and mass processing. Moreover, the method fails to resolve the problem associated with a mixture of optically active CNTs with various indices (n, m) that are obtained.

There is a method (Non-Patent Documents 9 and 10) of using a density-gradient ultracentrifugation method to optically resolve CNTs that have been dispersed by optically active surfactant. According to this method, a very expensive device, called ultracentrifuge, is used. Moreover, the ultracentrifugation operation requires a long time. Furthermore, there is a limit on how bigger the ultracentrifuge itself can be, and a plurality of ultracentrifuges need to be installed in parallel. Therefore, the problem is that such processes for automation are difficult.

All of the above-described separation methods require optically active dispersants. Therefore, the problem is that, before the optical activity of CNTs is utilized, the removal of the dispersants is required.

As described above, all of the conventional methods cannot solve the above-described problems. There are calls for development of a method of separating optically active single-structure CNTs based on a new idea.

The inventors have completed the invention described below (Patent Documents 1 to 4), by undertaking development of a novel method for separation of metallic and semiconducting CNTs, which is different from conventional methods. According to this invention, the use of specific types of dispersant and gel in combination enables the gel to selectively adsorb semiconducting CNTs, thereby making it possible to separate metallic CNTs. During the separation, through electrophoresis (Patent Documents 1 and 2) or through centrifugation, freeze and squeeze, diffusion, permeation or the like (Patent Documents 3 and 4), semiconducting CNTs that have been adsorbed to the gel are separated from CNTs that have not been adsorbed. These methods can obtain both metallic CNTs and semiconducting CNTs, boasts a high recovery rate, and can isolate in a short period of time. Moreover, the equipment is inexpensive, and mass processing and automation of separation are possible. In this manner, the method is excellent in industrial mass production of metallic and semiconducting CNTs.

Furthermore, the inventors have made the invention (Patent Document 5) as to a method of separating semiconducting CNTs with a single-(n, m) structure, in addition to the separation of metallic and semiconducting CNTs, by letting a large excess amount of CNT dispersion act in a small amount of gel. This invention, too, is a method characterized by a high recovery rate, a short period of time, and inexpensive equipment, and it is easy to realize mass processing and automated processing. In this manner, the method is excellent in industrial mass production of semiconducting CNTs with single (n, m).

The CNT separation methods of Patent Documents 1 to 5, which use gel, have succeeded in separation of metallic and semiconducting CNTs and separation of semiconducting CNTs with single (n, m). However, optical resolution of CNTs has yet to be examined.

### PRIOR ART DOCUMENTS

### Patent Documents

[Patent Document 1] Japanese Patent No. 5,177,623
[Patent Document 2] Japanese Patent No. 5,177,624
[Patent Document 3] International Publication Pamphlet No. WO2009/075293
[Patent Document 4] JP2011-195431A
[Patent Document 5] International Publication Pamphlet No. WO2011/108666

### Non-Patent Documents

[Non-Patent Document 1] Riichiro Saito, Hisanori Shinohara, “Fundamentals and applications of carbon nanotubes”, BAIFUKAN, p8 to 22
[Non-Patent Document 2] Nature Nanotechnology 2, (2007) 361-365
[Non-Patent Document 3] J. Am. Chem. Soc. 129, (2007) 15947-15953
[Non-Patent Document 4] ACS Nano. 2, (2008) 2045-2050
[Non-Patent Document 5] Org. Biomol. Chem., 10, (2012) 5830-5836
[Non-Patent Document 6] J. Am. Chem. Soc. 132, (2010) 10876-10881
[Non-Patent Document 7] J. Am. Chem. Soc. 134, (2012) 12700-12707
[Non-Patent Document 8] J. Am. Chem. Soc. 134, (2012) 13196-13199
[Non-Patent Document 9] Nano Res 22, (2009) 69-77
[Non-Patent Document 10] Nature Nanotechnology 5, (2010) 443-450

### SUMMARY OF THE INVENTION

### Problems to be Solved by the Invention

The present invention has been made in view of the above circumstances. The object of the present invention is to provide a method of accurately separating optically active CNTs of single (n, m) without using optically active dispersants, and optically active carbon nanotubes obtained by the method.

### Means for Solving the Problems

The inventors explored ways to solve the above problems. The inventors found that, through a separation process in which a large excess amount of CNT dispersion is reacted with a small amount of gel, CNTs that are different in optical activity can be separated. The inventors also found that: the number of types of (n, m) CNTs contained in a sample is preferably reduced through a separation process in which a large excess amount of CNT dispersion is reacted with a small amount of gel; the sample in which the number of types of CNTs has been reduced is then repeatedly subjected to a similar separation process again; and CNTs that are different in optical activity can be separated as a result.

According to the separation method of the present invention, it is possible to separate CNTs that are different in optical activity without using optically active dispersants. The possible reason is that, since a gel carrier that is to be used for the separation is optically active polysaccharide, a high degree of optical resolution of CNTs has been achieved because of a difference in the structure of (n, m) of CNTs and as a result of the gel exhibiting different kinds of interaction for CNTs that are different in optical activity. There have so far been no reports that CNTs that were different in optical activity were separated by making use of the optical activity of the gel. Therefore, it can be said that the present invention is a very creative invention. Furthermore, since a column separation can be applied, it is possible to perform mass processing and automated separation. Thus, the present invention is excellent in low-cost industrial mass production of CNTs that are different in optical activity.

The present invention has been made based on the above-mentioned novel findings.

That is, according to this application, the following invention is provided:

<1> A method of separating and recovering carbon nanotubes that are different in optical activity, characterized by including:

a step of letting gel react with a carbon nanotube dispersion that contains carbon nanotubes whose amount exceeds an amount of carbon nanotubes that can be adsorbed to the gel, so that optically active carbon nanotubes with a strong adsorption force to the gel are adsorbed to the gel;

a step of separating unadsorbed carbon nanotubes which are weak in adsorption force and whose optical activity is different from the optical activity; and

a step of retrieving carbon nanotubes adsorbed to the gel by letting an eluent react with the post-separation gel.

<2> The method of separating and recovering carbon nanotubes according to <1>, characterized in that the gel fills a column.
<3> A method of separating and recovering carbon nanotubes that are different in optical activity, characterized by including:

a step of having n gel-filled columns connected in series (n≧2, n: natural number) and letting a carbon nanotube dispersion react with the first column until carbon nanotubes are adsorbed to the gel of the n^{th} column, so that carbon nanotubes that rank first to n^{th} in terms of adsorption force are adsorbed to the gel of each of the n columns;

a step of separating a solution that contains carbon nanotubes that are so weak in adsorption force that the carbon nanotubes are not adsorbed to the gel of any of the columns; and

a step of retrieving n types of carbon nanotubes that are adsorbed to the gel of each of the columns and are different in adsorption force, thereby obtaining the n types of carbon nanotubes that are adsorbed to the gel of the n columns and are different in optical activity, and carbon nanotubes that are not adsorbed to the gel and are different in optical activity from the carbon nanotubes.

<4> Optically active carbon nanotubes obtained by the separation and recovery method claimed in one of <1> to <3>, characterized in that the carbon nanotubes include, as main component, those with chiral indices (5, 4), (7, 6), (9, 4), (8, 6), or (8, 7).

### Advantages of the Invention

According to the present invention, without the need for special reagents and equipment, it is possible to separate CNTs with single (n, m) that are different in optical activity. With sodium dodecyl sulfate (SDS), one of the most inexpensive surfactants, and the gel that can be repeatedly used, and a separation device that can be automated and made large in size, an extremely low-cost, high-throughput separation (which can be performed in a short period of time and yield a large amount) can be easily realized. The separation can be done only with a dispersant with no optical activity, such as SDS. Without the need to remove the dispersant, the CNTs can be applied without hampering the characteristics of the optically active CNTs.

The optically active gel is in a solid phase. Therefore, there is no need to worry about the gel being mixed into the separated CNT sample solution. The present invention may be applied to a continuous separation process that uses a column, and a batch-type separation process. The use of serial columns makes it possible to obtain a plurality of types of CNTs that are different in optical activity at once with high accuracy. Actually, the present invention is the first to have succeeded in separating optically active CNTs of (7, 6), (9, 4), (8, 6), and (8, 7), which other methods so far failed to separate. In this manner, the present invention provides a highly effective method, by which CNTs with single (n, m) that are different in optical activity can be separated.

### BRIEF DESCRIPTION OF THE DRAWINGS

FIG. 1 shows optical absorption spectrums of samples that have been subjected to preliminary separation prior to optical resolution.

FIG. 2A shows optical absorption spectrums of samples (Col. 1 to 9) after optical resolution; the upper part shows an optical absorption spectrum of sample (C1) following preliminary separation.

FIG. 2B shows circular dichroism spectrums (upper and middle parts) of (7, 3) CNT (Col. 1, 2) after optical resolution, and a corresponding optical absorption spectrum (lower part).

FIG. 2C shows circular dichroism spectrums (upper and middle parts) of (6, 4) CNT (Col. 3, 4) after optical resolution, and a corresponding optical absorption spectrum (lower part).

FIG. 2D shows circular dichroism spectrums (upper and middle parts) of (6, 5) CNT (Col. 5 to 7) after optical resolution, and a corresponding optical absorption spectrum (lower part).

FIG. 3 shows an optical absorption spectrum of (7, 5) CNT after optical resolution and a circular dichroism (CD) spectrum.

FIG. 4 shows an optical absorption spectrum of (7, 6) CNT after optical resolution and a circular dichroism (CD) spectrum.

FIG. 5 shows an optical absorption spectrum of (8, 4) CNT after optical resolution and a circular dichroism (CD) spectrum.

FIG. 6 shows an optical absorption spectrum (Left) of (9, 4) CNT after optical resolution and a circular dichroism (CD) spectrum.

FIG. 7 shows an optical absorption spectrum of (8, 6) CNT after optical resolution and a circular dichroism (CD) spectrum.

FIG. 8 shows an optical absorption spectrum of (8, 7) CNT after optical resolution and a circular dichroism (CD) spectrum.

FIG. 9 shows a pre-separation CD spectrum (upper part) and a post-separation CD spectrum (lower part) in the case where (6, 5)CNT that does not exhibit optical activity is used as sample and optical resolution is carried out again.

FIG. 10 shows an optical absorption spectrum of (5, 4)CNT after optical resolution and a circular dichroism (CD) spectrum.

### BEST MODE FOR CARRYING OUT THE INVENTION

Hereinafter, the present invention will be described in detail.

Incidentally, in the case of the present invention, “optically active” CNTs to be separated are those having exhibited optical activity in the measurement of circular dichroism spectrum, and it was confirmed by optical absorption spectrums that the CNTs are of single (n, m) or a limited number of types of (n, m). Accordingly, such post-separation optically active CNTs may be CNTs of a single structure with optical activity taken into account, as well as mixtures of two or more of types that have been extracted as specific structures. Moreover, the mixtures may contain a slight amount of any other structures as long as the amount is within a range in which the selective separation and recovery of such specific optically-active CNTs can be identified based on the above measurement.

The separation of the present invention is targeted not only at mixtures containing CNTs with various indices (n, m) (which may be simply referred to as CNTs, hereinafter), but also at mixtures containing CNTs with a limited number of indices (n, m) and CNTs of single (n, m). The separation may also cover optically inactive racemic bodies that include completely equal amounts of enantiomers, as well as mixtures of CNTs containing enantiomers in an arbitrary ratio. The present invention relates to a method of separating CNTs that are different in optical activity from mixtures of the various CNTs.

The method of the present invention for separating CNTs that are different in optical activity is designed to separate and refine optically active CNTs having a strong adsorption force by adding an excess amount of CNT dispersion that is obtained as described later to gel that has been loaded into a column.

According to the method of the present invention, if a to-be-separated sample is a mixture containing CNTs of various indices (n, m), it is preferred that: the number of types of (n, m) CNTs contained in the sample be reduced by a separation process by which a large excess amount of CNT dispersion is reacted with a small amount of gel, and the sample in which the number of types of CNTs has been reduced be repeatedly subjected to the same separation process again in order to separate CNTs that are different in optical activity.

An excess amount of CNT dispersion means that the amount is greater than the adsorption capacity of the gel loaded into the column on carbon nanotubes. That is, the amount is an amount that is eluted after CNTs that should have been adsorbed to the gel fail to be adsorbed to the column when an amount of CNTs poured into the column is gradually increased, as in the case of CNTs that are not supposed to be adsorbed to the gel. Suppose that CNTs are poured into the column, and that some CNTs will be retrieved without being adsorbed to the gel that was loaded into the column. Then, the retrieved CNTs are poured again into a similar column that is freshly prepared. In such a case, if CNTs that are to be adsorbed to the gel loaded into the column are left, the amount of CNTs that were initially poured into the column is regarded as an excess amount.

The following is a possible reason why only CNTs having specific optical activity are bonded when an excess amount of CNT dispersion is reacted with the gel that was loaded into the column. If an excess amount of CNT dispersion relative to the gel that was loaded into the column is poured into the column, specific optically-active CNTs with a strong adsorption force are more likely to be adsorbed to the gel than those with a weak adsorption force, among various kinds of CNTs. The CNTs with a weak adsorption force are not adsorbed to the gel and are discharged. As a result, the types of CNTs that are adsorbed to the gel are limited to specific optically-active CNTs with a strong adsorption force. In this manner, only specific types of CNTs can be obtained.

Furthermore, if any number of similar columns are connected in series, and an excess amount of CNT solution is added to the gel loaded into the columns, and separation is carried out, a plurality of types of CNTs that are different in optical activity can be separated at once. That is, the first column attracts optically active CNTs with a strongest adsorption force. The second column attracts optically active CNTs with a strongest adsorption force among the CNTs that are not adsorbed to the first column. The same process is repeated, and CNTs that are different in optical activity are bound to the third column, fourth column, fifth column, . . . in order of adsorption force. As a result, CNTs with specific optical activities can be separated at the same time.

All the carbon nanotubes used for separation can be separation targets of the present invention, regardless of the production method or shape (diameter or length) of the carbon nanotubes, or the structure (such as single-wall or double-wall structure), or the like.

### [Preparation of CNT Dispersion]

What is usually synthesized is bundles of dozens or hundreds of CNTs (bundles), which contain CNTs of various structures. Prior to optical resolution of CNTs, what is important is to disperse and solubilize CNTs so that each CNT is isolated and exists in a stable manner for a long time.

Accordingly, a mixture of CNTs is added to a solution to which a surfactant has been added as a dispersing agent, and ultrasonication is carried out sufficiently, so that CNTs are dispersed and isolated. The liquid that underwent the dispersion process includes the CNTs that have been dispersed and isolated, bundles of CNTs that have not been dispersed and isolated, synthetic byproducts such as amorphous carbons, metal catalysts, and the like.

The dispersion obtained as a result of ultrasonication is subjected to centrifugal separation by a centrifuge. As a result, bundles of CNTs, amorphous carbons, and metal catalysts are precipitated. Meanwhile, isolated CNTs that form micelles with the surfactant can be recovered as supernatant. The obtained supernatant is used as a sample for separation of CNTs.

Water is the most preferred to be used as a solvent for preparation of CNT dispersion. Therefore, water is used in the preparation of CNT dispersion.

As the surfactant, any of the following substances can be used: anionic surfactants, cationic surfactants, amphoteric surfactants, and non-ionic surfactants. The optical resolution of CNTs that uses the gel does not require the use of optically active dispersants.

The anionic surfactants preferably include alkyl sulfate-based surfactants with a carbon number of 10 to 14; dodecane sulfonic acid; dodecanoyl sarcosine; dodecanoic acid; and cholic acid. The amphoteric surfactants preferably include n-dodecylphosphocholine. These surfactants can be used in mixture, or can be used in combination with other surfactants.

The surfactants that may be used in combination include such dispersants as high molecular polymers, DNAs, and proteins, as well as anionic surfactants, cationic surfactants, amphoteric surfactants, and non-ionic surfactants. The concentration of the dispersants such as surfactants varies depending on the type or concentration of CNTs used, the type of dispersants used, and the like. For example, the final concentration may be 0.01% to 25%.

According to this method, the concentration of CNTs in the dispersion can be 1 μg/ml to 10 mg/ml, or preferably 0.1 mg/ml to 1 mg/ml. The amount of sample to be added varies depending on the type, number, and composition ratio of to-be-separated substances contained in the sample, and the like. For example, the amount could be several times or several tens of times the binding capacity of the gel carrier.

### [Gel to be Used]

The gels to be used include conventionally-known saccharide-based gels, such as dextran-based gel (Sephacryl: homopolymer of allyl dextran and N,N′-methylene bis-acrylamide, GE Healthcare), agarose gel, and starch gel. The gel may be a mixture of these gels, or may include components of these gels, mixtures of other substances, or compounds.

As for the concentration of the gel, for example, the final concentration is preferably 0.01% to 25%.

### [Separation]

The separation of the present invention is not limited to a column method. For example, the separation of the present invention can also be applied to a batch method by which a small amount of gel is added to a large excess amount of CNT dispersion so that only substances with strong adsorption forces are adsorbed to the gel and are separated and recovered.

As for the separation that uses the column, in order to send liquid to the column, a method of using an open column to send liquid as a solvent falls by gravity, and a method of using a pump to feed a solution to a sealed column, and other methods may be employed. In the case of the separation that uses the pump, the flow rate can be increased to carry out mass processing. Automatic separation is also possible by a chromatographic device.

Even in the case where columns are connected in series, the entire process of separation can be automated by placing appropriate valves before and after the columns.

In the case of CNTs that are weak in bonding strength and are unlikely to be adsorbed to the gel, the adsorption force may be increased by changing the concentration of dispersants in the solution that is used for separation and taking other steps. In this manner, separation is made possible.

As an eluate that is used to recover CNTs adsorbed to the gel, a solution that contains dispersants such as surfactants can be used.

In order to obtain information about (n, m) of CNTs, an ultraviolet—visible—near-infrared optical absorption spectrum measurement is used.

Results obtained when CNTs (HiPco-CNTs, with diameter of 1.0±0.3 nm) that were synthesized by HiPco method were used will be explained as an example.

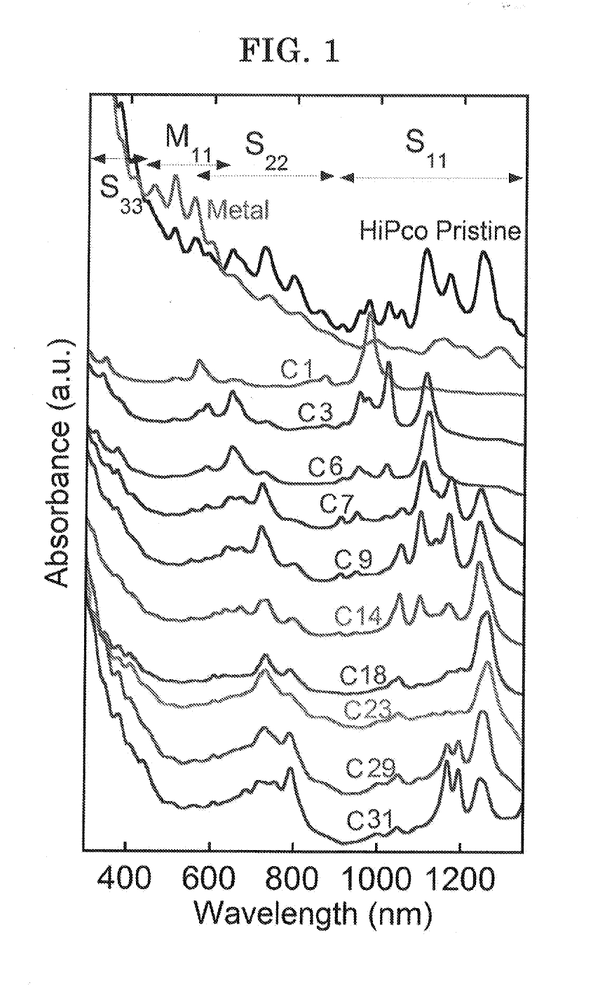

FIG. 1 is a diagram showing optical absorption spectrums of samples that have been subjected to preliminary separation prior to optical resolution in Example 1 described later.

In the diagram, an absorption wavelength range (about 450 to 650 nm), called M₁₁, was associated with metallic CNTs. Three absorption wavelength ranges, S₁₁ (greater than about 900 nm), S₂₂ (around 650 to 900 nm), and S₃₃ (less than about 450 nm), are associated with semiconducting CNTs. There is a correlation between these absorption wavelength ranges and diameter distribution of CNTs. The wider the diameter distribution becomes, the larger the absorption wavelength ranges will be.

In the case of HiPco-CNTs that had yet to be separated (pre-separation samples), several peaks were observed. The absorption wavelength ranges of S₁₁, S₂₂, M₁₁, and S₃₃ slightly overlapped with each other.

In contrast, semiconducting CNTs of a specific one type of (n, m) had one characteristic peak each in S₁₁, S₂₂, and S₃₃ (which are equivalent to E₁₁, E₂₂, and E₃₃). Therefore, once the types of (n, m) contained in the sample are reduced, it becomes possible to obtain information as to which (n, m) is contained. In the fractions of C1 to C31 in FIG. 1 (samples obtained by collecting CNTs adsorbed in each column, excerpt), the number of peaks was smaller than that of pre-separation substances. Therefore, it is clear that each fraction contained only CNTs of a limited number of indices (n, m).

However, from the optical absorption spectrums, detailed information about optical activity cannot be obtained.

In order to obtain information about optical activity, a circular dichroism dispersion meter is used to measure circular dichroism spectrums (CD spectrums). A flat spectrum where there is no structure across the entire wavelength is obtained for substances with no optical activity. However, in the case of substances that exhibit optical activity, positive or negative peaks are observed. As a result, when used in combination with the above-described data about optical absorption spectrums, it is possible to identify which (n, m) of CNTs circular dichroism comes from.

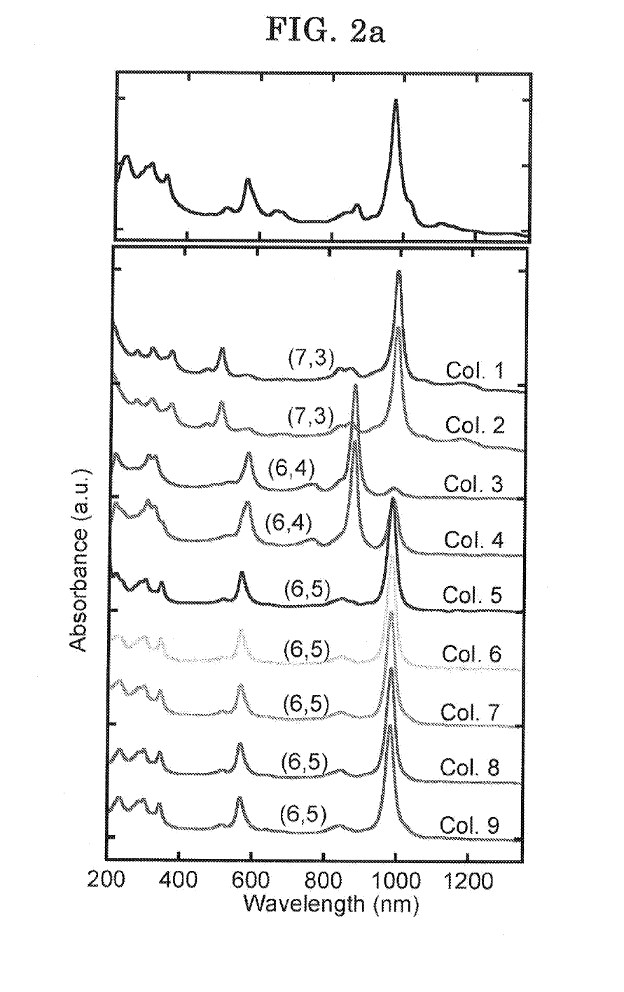

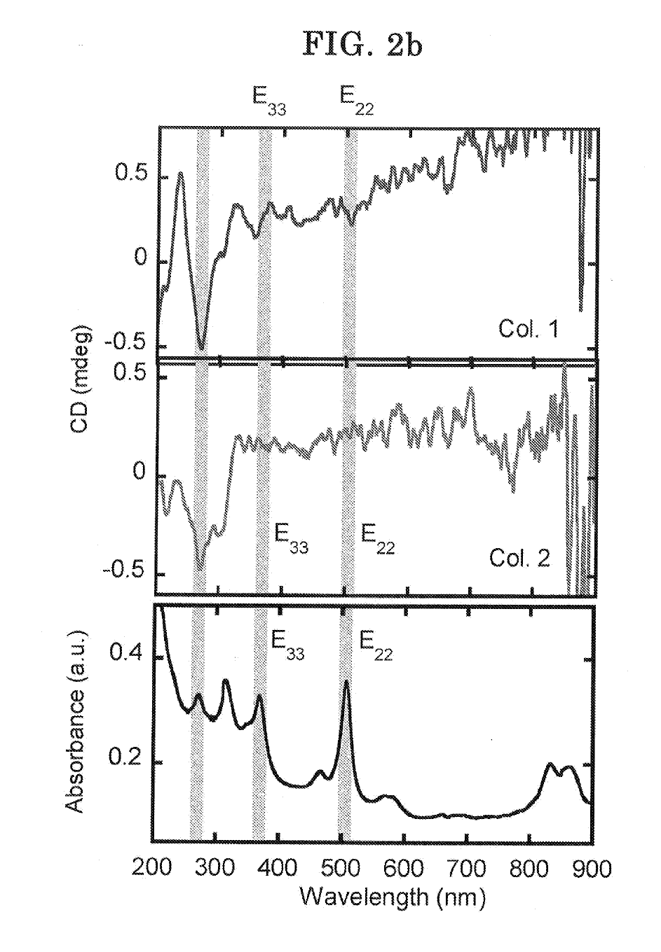

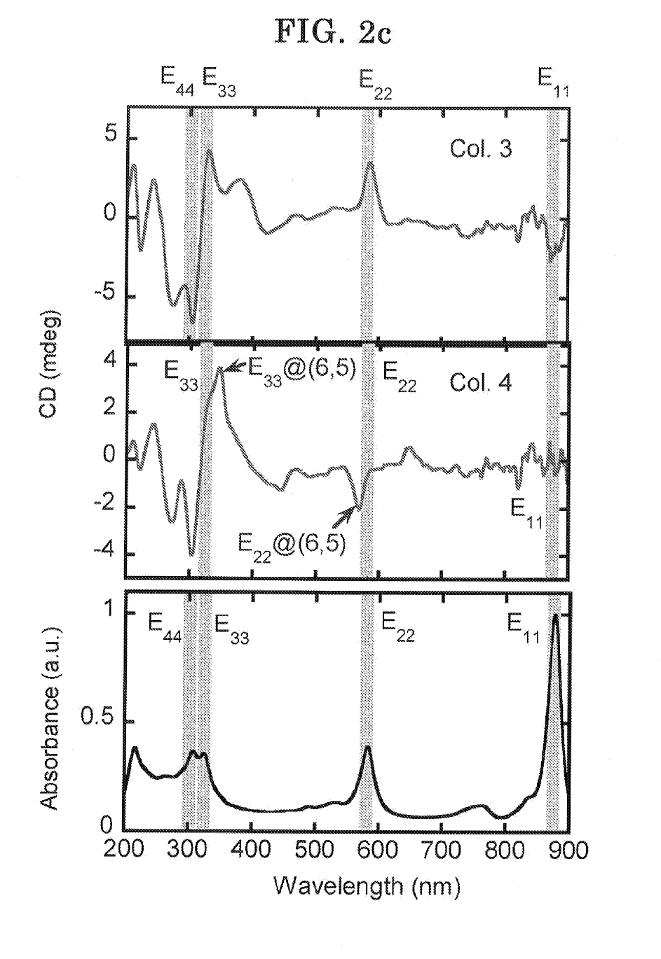

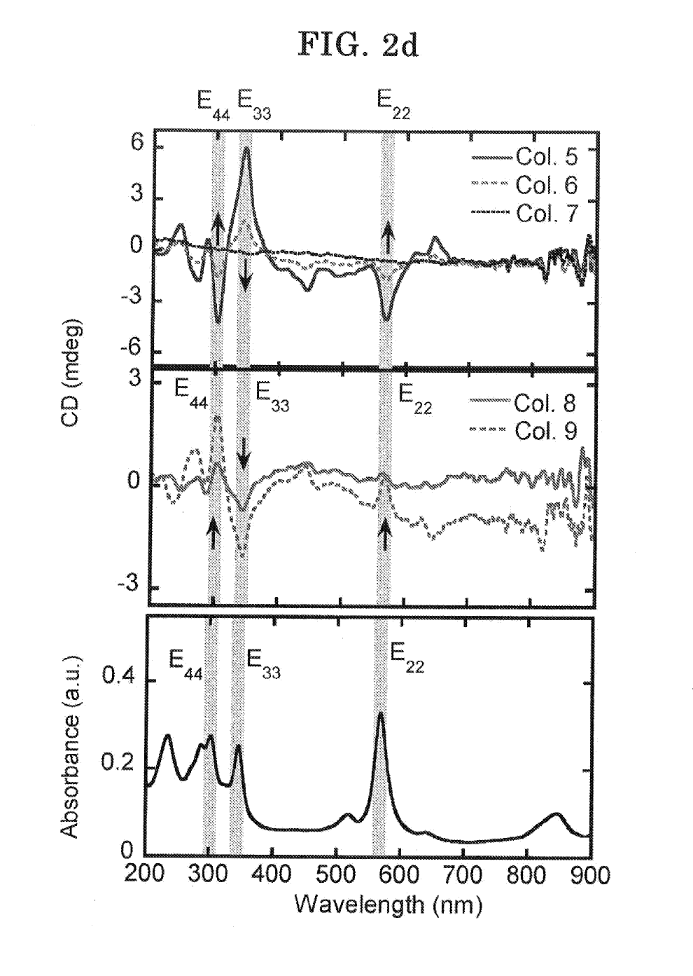

For example, FIG. 2d shows the results of separation of CNTs having optical activity of (6, 5) CNT, in Example 1 described later. At the same positions as peak positions of E₂₂ and E₃₃ of optical absorption spectrums in the lower part of FIG. 2d, peaks were observed in CD spectrums (in upper and middle parts of FIG. 2D). This confirms the separation of optically active (6, 5) CNTs. The peaks in Col. 5, 6 were opposite to the peaks in Col. 8, 9 in terms of whether the peaks are positive or negative. This proves that CNTs that were different in optical activity were separated.

### EXAMPLES

The present invention will be described in detail through examples. However, the present invention is not limited to the examples.

### Example 1

In this example, the number of types of (n, m) CNTs contained in a sample was reduced during preliminary separation, and the sample was used, and optically active CNTs with single (n, m) were separated.

### [Preparation of CNT Dispersion]

To 100 mg of Hipco-CNTs (Nanolntegris, CNTs synthesized by chemical vapor deposition method, diameter of 1.0±0.3 nm), a 2% SDS aqueous solution (100 ml) was added. While being cooled in cold water, the solution was subjected to ultrasonication for 9 hours at an output of 30 W/cm² with the use of a tip-type ultrasonic homogenizer (Sonifier, Branson Ultrasonics Corporation, tip diameter: 0.5 inches). The dispersion obtained by the ultrasonication was subjected to ultracentrifugal separation (289,000×g, 15 minutes). After that, 90% of supernatant was recovered. This solution was used as CNT dispersion.

### [Preliminary Separation]

Gel beads (Sephacryl 5-200HR, GE Healthcare) were used as column carriers. The outlet of a plastic syringe that was 8 cm in length and 1.5 cm in inner diameter was staffed with cotton, and a column that was filled with 1.4 ml of gel beads was prepared. Serial columns, or 6 similar columns that were arranged vertically, were prepared. Pure water was dropped from the top column, and all the columns were equilibrated with pure water. Then, equilibration was carried out with a 2% SDS aqueous solution.

Then, 5 ml of the above CNT dispersion (0.15 ml/ml) was added to the top column. Then, a 2% SDS aqueous solution was added, and CNTs that were not adsorbed to the gel were recovered from the outlet of the bottom column. The columns were washed until the solution became colorless and transparent. Then, the columns were separated, and CNTs that were adsorbed to each of the columns were eluted from the columns with the use of a 5% SDS aqueous solution and were recovered, and were defined as fractions C1 to C6 respectively.

The solution that was recovered from the outlet of the bottom column and contained CNTs which were not adsorbed to the gel was diluted with pure water so that the SDS concentration was adjusted to 1.5%. Serial columns that were equilibrated with 1.5% SDS were used to carry out a similar separation. The fractions that were recovered from each of the columns were defined as C7 to C12 respectively. The solution that contained CNTs which could not be adsorbed to the gel with 1.5% SDS were subjected to a similar separation again with the use of serial columns that were equilibrated with 1.5% SDS. The fractions that were recovered from each of the columns were defined as C13 to C17 respectively (Since no CNTs were recovered from the bottom column, there was no fraction C18 at that point in time). Furthermore, the SDS concentration of the CNT solution that was recovered without being adsorbed to the gel with 1.5% SDS was changed to 1%, and a similar separation was repeatedly carried out three times. The obtained fractions were defined as C18 to C31 respectively. The CNT solution that failed to be adsorbed to the gel even with 1% SDS was recovered as unadsorbed fraction.

FIG. 1 shows optical absorption spectrums of each of the obtained fractions.

### [Optical Absorption Spectrums]

As for the optical absorption spectrums of CNTs, in the case of the semiconductor type, absorption peaks S₁₁, S₂₂, and S₃₃ were observed from the long wavelength side. In the case of the metal type, peak M₁₁ was observed at around between S₂₂ and S₃₃. The absorption peaks have different wavelengths of peaks depending on the diameter. If the diameter of CNTs is large, the peak would shift to the long wavelength side. If the diameter of CNTs is small, the peak would shift to the short wavelength side. Synthesized CNTs are mixtures of CNTs with various types and diameters. The optical absorption spectrums are observed as the peaks of these mixtures that have been overlapped.

According to the results of optical absorption spectrum measurement of FIG. 1, many peaks were observed in the case of pre-separation CNTs (Pristine). However, in the case of those (C1 to C31) that were adsorbed to and eluted from the columns, it is clear that the number of peaks in the regions S₁₁, S₂₂, and S₃₃ was smaller than that of pre-separation CNTs. This proves that, as a result of preliminary separation, each of the fractions contained only CNTs with a limited number of indices (n, m).

### [Separation of Optically Active CNTs]

With the use of CNTs with a limited number of types of (n, m), which were obtained as a result of preliminary separation, a separation of optically active CNTs was carried out. As the separation method, a method of using serial columns was used as described above.

In one example, results obtained when C1, which was obtained by preliminary separation, was used as separation sample will be described in detail with the use of FIGS. 2A to 2D.

Fraction C1, which was recovered with a 5% SDS solution, was diluted with pure water so that the SDS concentration was set to 2%, and a serial-column separation was carried out. FIG. 2a shows optical absorption spectrums of each of fractions (Col. 1 to 9) before and after separation. It was found that, as major products, Col. 1 and 2 contained (7, 3) CNTs, and Col. 3 and 4 contained (6, 4) CNTs, and Col. 5 to 9 contained (6, 5) CNTs. A circular dichroism spectrum of each of the fractions was measured.

FIG. 2D shows a summary of results of Col. 5 to 9 corresponding to (6, 5) CNTs.

As for the wavelengths (lower part of FIG. 2D) at which optical absorption peaks E₂₂ and E₃₃ that were unique to (6, 5) CNTs would appear, it is clear that, from Col. 5 toward Col. 9, the peaks would change from negative to positive at E₂₂, whereas the peaks would change from positive to negative at E₃₃ (upper and middle parts of FIG. 2D). This proves that optically active (6, 5) CNTs were separated. In the case of Col. 7, which was midway between Col. 5 and Col. 9, peaks were observed at E₂₂ and E₃₃ in the optical absorption spectrums. However, no peaks were observed in the circular dichroism spectrums. This means that (6, 5) CNTs existed as racemic bodies that included equal amounts of enantiomers.

FIG. 2C shows a summary of results of Col. 3 and 4 corresponding to (6, 4) CNTs.

In the case of (6, 4) CNTs, in the circular dichroism spectrums of Col. 3, peaks were observed in portions corresponding to E₁₁, E₂₂, and E₃₃, and it was found that one of the enantiomers increased (upper part of FIG. 2C).

In Col. 4, at a position that was different from the portions corresponding to E₂₂ and E₃₃, a peak (represented as E₂₂@(6, 5)) corresponding to E₂₂ of (6, 5)CNTs in the above-described Col. 5, and a peak (represented as E₃₃@(6, 5)) corresponding to E₃₃ were observed. The impact of (6, 5) CNTs that coexisted was large, making it difficult to identify enantiomeric separation of (6, 4) CNTs (middle part of FIG. 2C).

FIG. 2B shows a summary of results of Col. 1 and 2 corresponding to (7, 3) CNTs.

In the case of (7, 3) CNTs, in Col. 1, in both the portions corresponding to E₂₂ and E₃₃, negative peaks were observed. Accordingly, it was found that one of the enantiomers slightly increased.

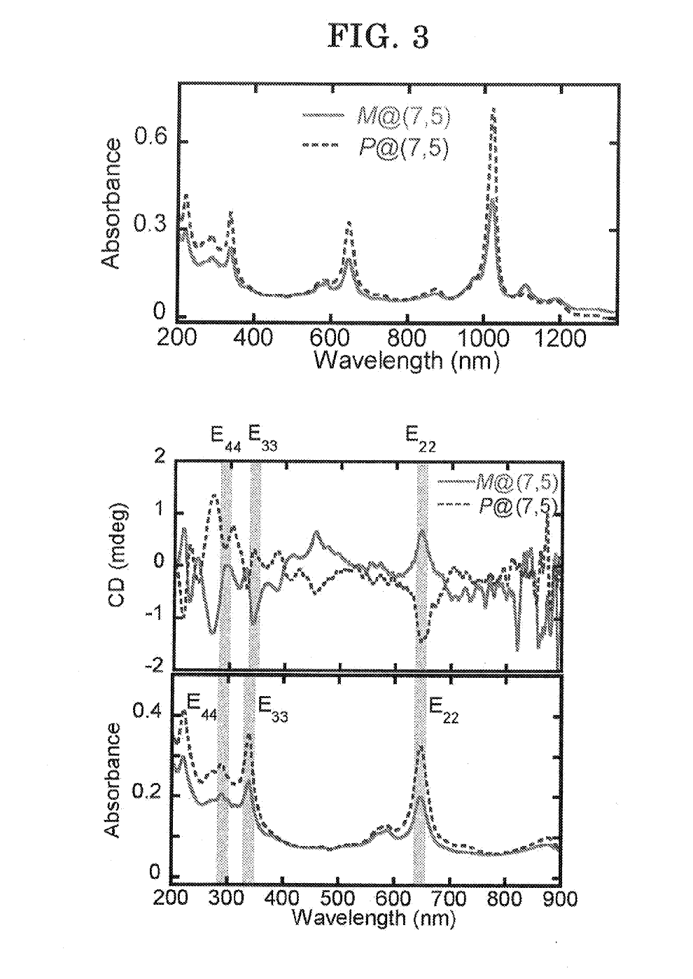

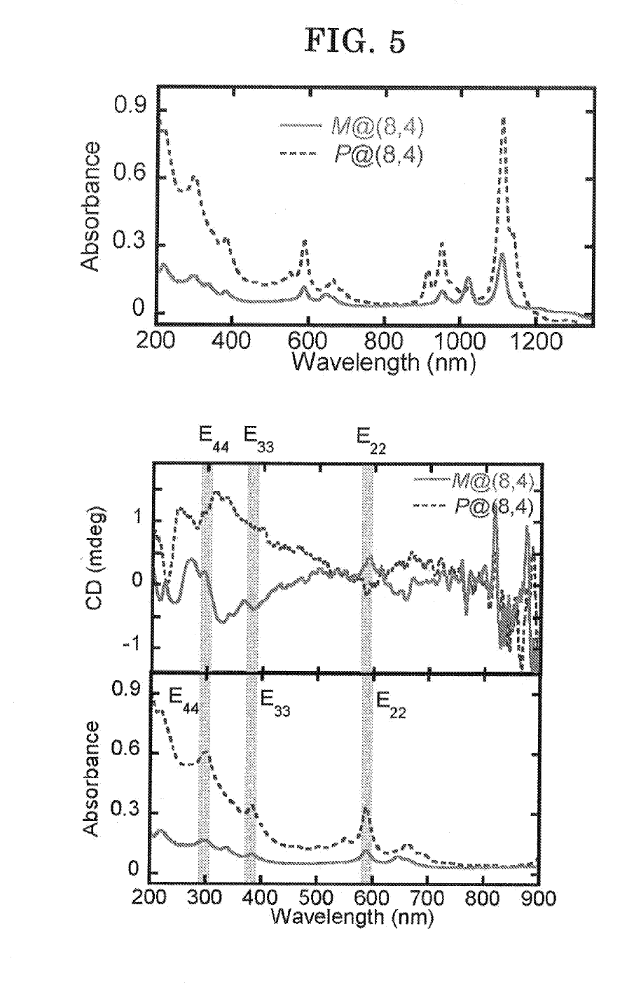

FIGS. 3 to 8 show the optical absorption spectrums and circular dichroism spectrums of optically active enantiomers of (7, 5), (7, 6), (8, 4), (9, 4), (8, 6), and (8, 7) CNTs that were obtained in the same way. In each of the diagrams, the upper part shows optical absorption spectrums, and the part below the upper part shows circular dichroism (CD) spectrums. For comparison, below each CD spectrum, an optical absorption spectrum of a corresponding wavelength range is displayed. In the CD spectrum, if a peak at E₂₂ is positive, the peak is represented by M@(n, m). If a peak at E₂₂ is negative, the peak is represented by P@(n, m).

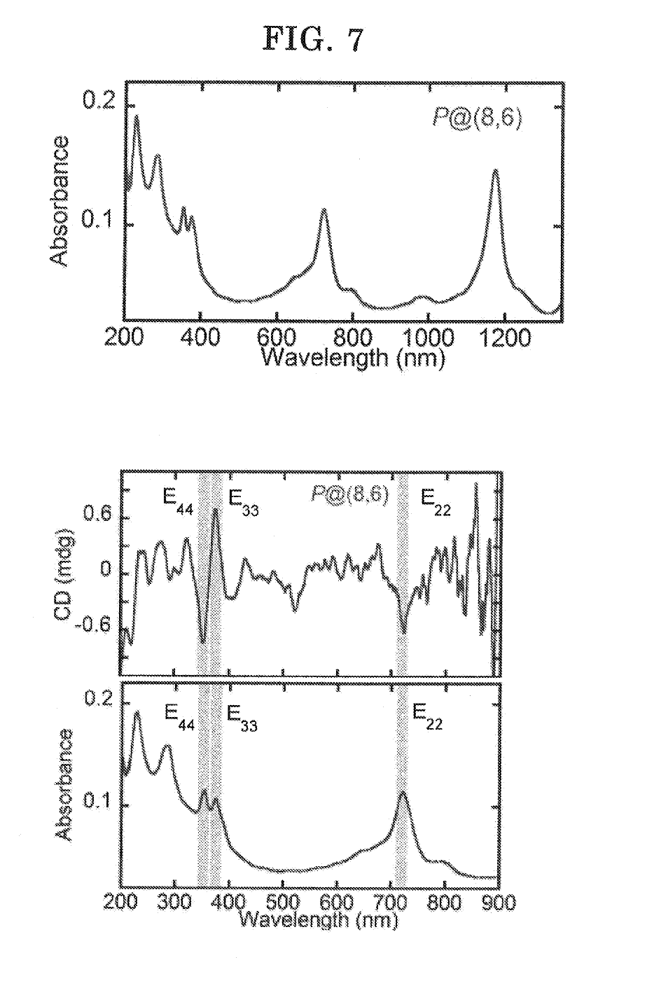

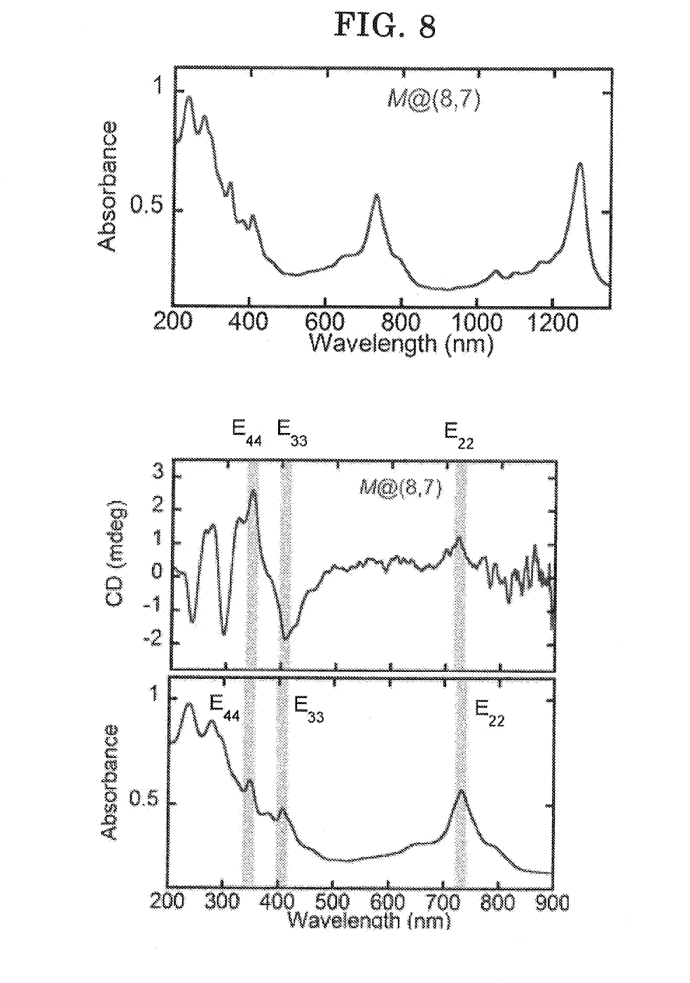

As shown in FIGS. 7 and 8, in the case of (8, 6) CNTs and (8, 7) CNTs, the only thing obtained was a concentrate of one of enantiomers.

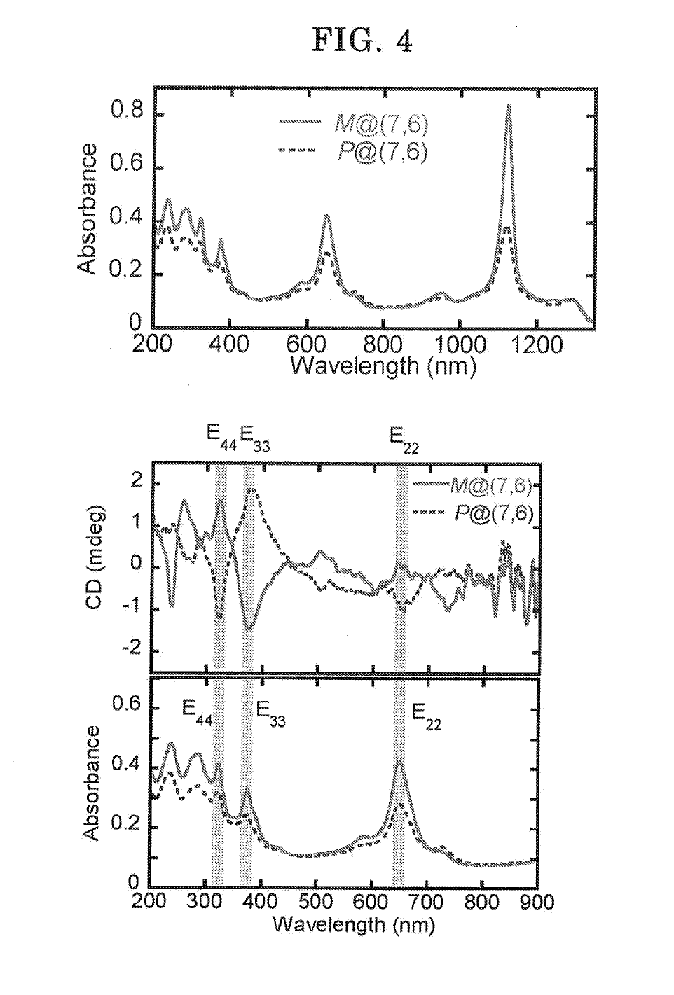

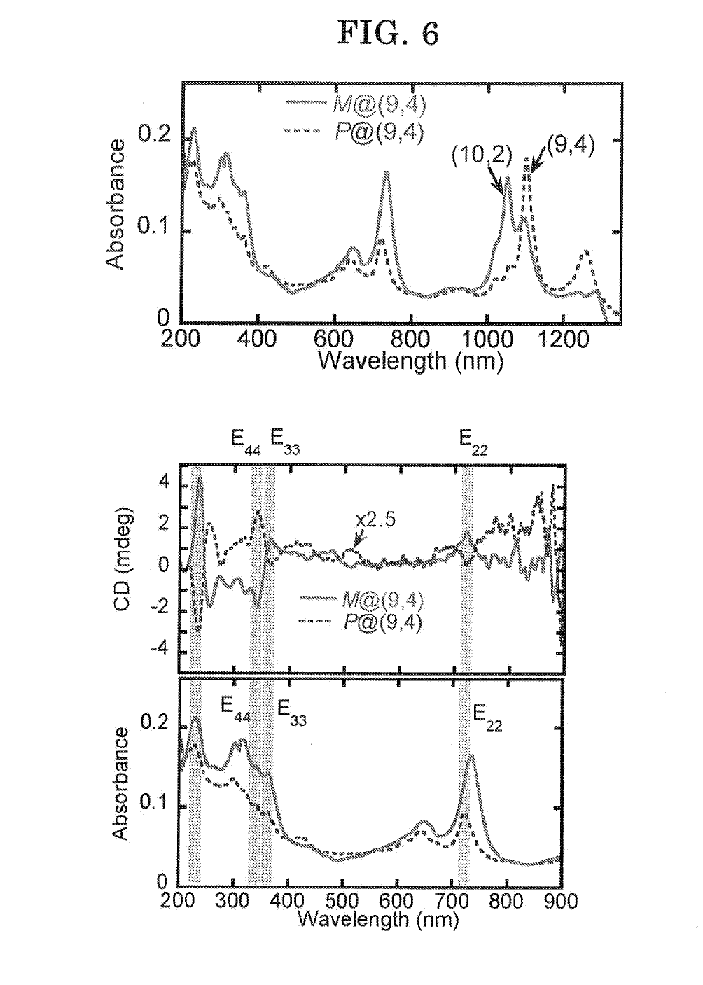

Among the CNTs that were optically separated, the CNTs with optical activity of (7, 6) shown in FIG. 4, the CNTs with optical activity of (9, 4) shown in FIG. 6, the CNTs with optical activity of (8, 6) shown in FIG. 7, and the CNTs with optical activity of (8, 7) shown in FIG. 8 were the world's first to have been separated, with no reports so far of such separation.

### Example 2

In this example, optically inactive (6, 5) CNTs that were obtained in Col. 7 of the above-described Example 1 were used. The same separation as that described in paragraph [0045] was carried out again to try an optical resolution.

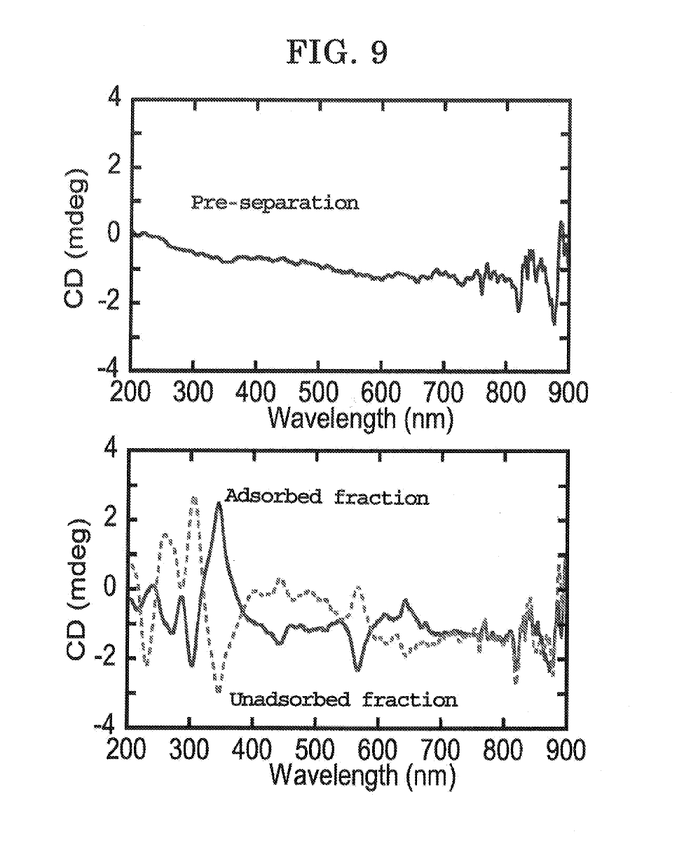

FIG. 9 shows the results. In the diagram, the upper part shows the results of the pre-separation, and the lower part shows the results of the post-separation.

As can be seen from FIG. 9, optically active CNTs can be separated by carrying out the same separation again with the use of the optically inactive CNTs.

### Example 3

In this example, CNT dispersion conditions and dispersion parameters were optimized so that optical resolution of (5, 4) CNTs could be carried out without preliminary separation.

### [Preparation of CNT Dispersion]

A CNT dispersion was prepared in the same way as in Example 1 except that preparation conditions of the CNT dispersion were changed in such a way that the SDS concentration came to 2.75%, the time for ultrasonication was set at 20 hours, and the ultracentrifugation conditions were (210,000×g, 2 hours).

### [Separation]

Four columns filled with 2 ml of gel that was equilibrated with a 2.75% SDS aqueous solution were arranged in series, and 80 ml of the CNT dispersion was added from the top column.

Then, a 2.75% SDS aqueous solution was added to the top column, and CNTs that were not adsorbed to the gel were washed away. Then, each of the columns was separated, and CNTs that were adsorbed to each of the columns were eluted from the columns by 5 ml of a 5% SDS aqueous solution and were recovered.

To concentrate the recovered CNT solution, the 5% SDS aqueous solution that was recovered from each of the columns was mixed, and was diluted by water so that the SDS concentration came to 2.5%. Then, CNTs were adsorbed to a column containing 1 ml of gel that was equilibrated with 2.5% SDS, and were eluted from the column and recovered with the use of 1 ml of 5% SDS.

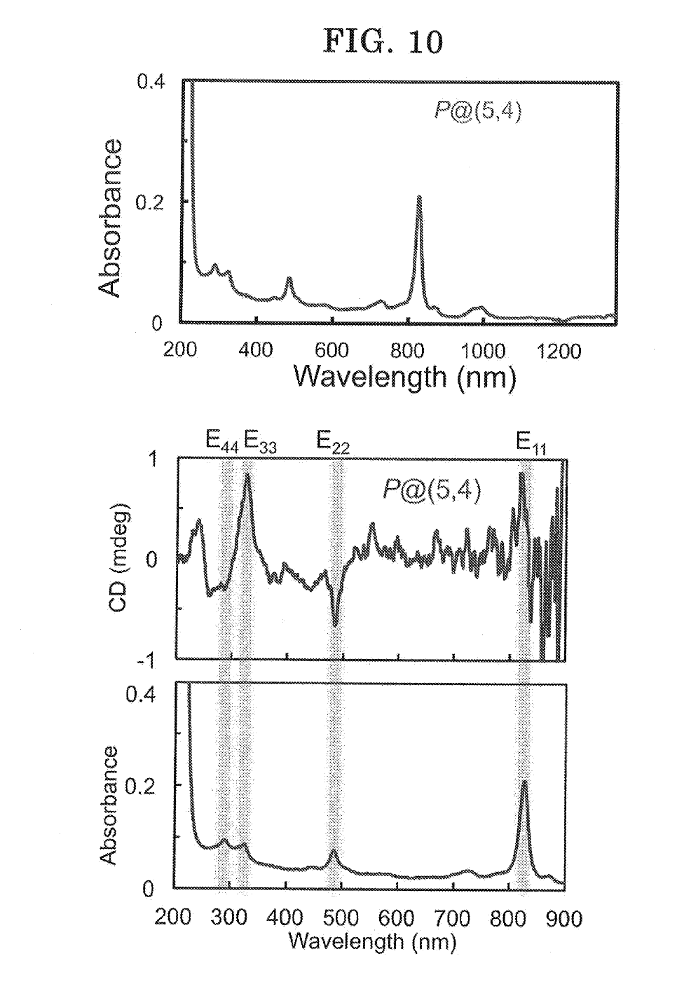

FIG. 10 shows results of an optical absorption spectrum and circular dichroism spectrum of the obtained CNTs. As can be seen from the diagram, the optimization of the conditions makes it possible to separate optically active (5, 4) CNTs without preliminary separation.

1. A method of separating and recovering carbon nanotubes that are different in optical activity, characterized by comprising:
a step of letting gel react with a carbon nanotube dispersion that contains carbon nanotubes whose amount exceeds an amount of carbon nanotubes that can be adsorbed to the gel, so that optically active carbon nanotubes with a strong adsorption force to the gel are adsorbed to the gel;
a step of separating unadsorbed carbon nanotubes which are weak in adsorption force and whose optical activity is different from the optical activity; and
a step of retrieving carbon nanotubes adsorbed to the gel by letting an eluent react with the post-separation gel.

2. The method of separating and recovering carbon nanotubes according to claim 1, characterized in that
the gel fills a column.

3. A method of separating and recovering carbon nanotubes that are different in optical activity, characterized by comprising:
a step of having n gel-filled columns connected in series (n≧2, n: natural number) and letting a carbon nanotube dispersion react with the first column until carbon nanotubes are adsorbed to the gel of the n^{th} column, so that carbon nanotubes that rank first to n^{th} in terms of adsorption force are adsorbed to the gel of each of the n columns;
a step of separating a solution that contains carbon nanotubes that are so weak in adsorption force that the carbon nanotubes are not adsorbed to the gel of any of the columns; and
a step of retrieving n types of carbon nanotubes that are adsorbed to the gel of each of the columns and are different in adsorption force, thereby obtaining the n types of carbon nanotubes that are adsorbed to the gel of the n columns and are different in optical activity, and carbon nanotubes that are not adsorbed to the gel and are different in optical activity from the carbon nanotubes.

4. Optically active carbon nanotubes obtained by the separation and recovery method claimed in claim 1, characterized in that
the carbon nanotubes include, as main component, those with chiral indices (5, 4), (7, 6), (9, 4), (8, 6), or (8, 7).
